(19) United States
(12) Patent Application Publication
(10) Pub. No.: US 2025/0159538 A1
(43) Pub. Date: May 15, 2025

(54) Method for Prioritizing Emergency Communications Over the Network in the Event of Aircraft Emergency

(71) Applicant: GOGO BUSINESS AVIATION LLC, Broomfield, CO (US)

(72) Inventors: Christopher Michael Rippe, Arvada, CO (US); Todd A. Krawcyzk, Boulder, CO (US)

(21) Appl. No.: 18/389,457

(22) Filed: Nov. 14, 2023

(51) Int. Cl. H04W 28/02; H04W 28/20; H04W 76/50

(52) U.S. Cl. CPC H04W 28/0215; H04W 28/20; H04W 76/50

(57) ABSTRACT

A computer-implemented method for prioritizing communications in an aircraft emergency may include receiving, via an application programming interface, a first indication from a user device that an emergency event has begun aboard an aircraft; identifying a first state representative of a first set of communication capabilities for at least the user device and a second state representative of a second set of communication capabilities for at least the user device such that the second set of communication capabilities allows for improved communication from the user device compared to the first set of communication capabilities; causing at least the user device to transition from the first state to the second state; receiving a second indication from the user device to transition from the second state to the first state; and causing at least the user device to transition from the second state to the first state.

### FIELD OF THE INVENTION

The present disclosure is related generally to network communications. In particular, the present disclosure relates to prioritizing emergency communications over the network in the event of an aircraft emergency.

### BACKGROUND

In an emergency situation, a person may use an electronic device to relay information about an emergency event to emergency service personnel. Such information is often communicated over the internet. When there is a medical emergency aboard an aircraft, a person may likewise use an internet connection to communicate with emergency personnel on the ground by using a video or voice call.

In a medical emergency aboard an aircraft, the device being used to communicate with medical personnel should have the best quality internet connection to communicate information about the emergency. However, the connection to the internet aboard an aircraft is limited by the equipment on board, the type of internet connection, and the signal strength of the connection. Providers of in-flight internet and other connectivity services may offer various rate plans for accessing various wireless communication services aboard an aircraft, and thus the connection of a particular device aboard the aircraft may be further limited by the rate plan that the user of the device has selected. Additionally, there may be multiple devices aboard the aircraft that are connected to the provided wireless communication services. Thus, the connection to such communication services aboard the aircraft may also be limited by the number of devices also utilizing network resources to connect to the internet. These factors may reduce the ability of the device communicating with emergency personnel to effectively relay information about the medical emergency. Accordingly, there is a need to develop systems and methods of modifying the communications capabilities of devices aboard an aircraft so that the device communicating information about the emergency maintains a high-quality connection.

### SUMMARY

The present aspects can relate to, inter alia, systems and methods for prioritizing emergency communications over the network in the event of an aircraft emergency.

In one aspect, a computer-implemented method for modifying communication capabilities for an emergency event may be provided. The method may be implemented via one or more processors and other electronic or electrical components. In one instance, the computer-implemented method may include (1) receiving, by one or more processors and via an application programming interface, a first indication from a user device that an emergency event has begun aboard an aircraft; (2) identifying, by the one or more processors, a first state representative of a first set of communication capabilities for at least the user device and a second state representative of a second set of communication capabilities for at least the user device such that the second set of communication capabilities allows for improved communication from the user device compared to the first set of communication capabilities; (3) causing, by the one or more processors and in response to receiving the first indication, at least the user device to transition from the first state to the second state; (4) receiving, by the one or more processors, a second indication from the user device to transition from the second state to the first state; and (5) causing, by the one or more processors and in response to receiving the second indication, at least the user device to transition from the second state to the first state.

In another aspect, a computer system for modifying communication capabilities for an emergency event may be provided. The computer system may include one or more processors and one or more non-transitory memories. The one or more processors may be configured to (1) receive, via an application programming interface, a first indication from a user device that an emergency event has begun aboard an aircraft; (2) identify, a first state representative of a first set of communication capabilities for at least the user device and a second state representative of a second set of communication capabilities for at least the user device such that the second set of communication capabilities allows for improved communication from the user device compared to the first set of communication capabilities; (3) cause, in response to receiving the first indication, at least the user device to transition from the first state to the second state; (4) receive a second indication from the user device to transition from the second state to the first state; and (5) cause, in response to receiving the second indication, at least the user device to transition from the second state to the first state.

In another aspect, a non-transitory computer-readable medium for modifying communication capabilities for an emergency may be provided. For example, the non-transitory computer-readable medium may include instructions to (1) receive, via an application programming interface, a first indication from a user device that an emergency event has begun aboard an aircraft; (2) identify, a first state representative of a first set of communication capabilities for at least the user device and a second state representative of a second set of communication capabilities for at least the user device such that the second set of communication capabilities allows for improved communication from the user device compared to the first set of communication capabilities; (3) cause, in response to receiving the first indication, at least the user device to transition from the first state to the second state; (4) receive a second indication from the user device to transition from the second state to the first state; and (5) cause, in response to receiving the second indication, at least the user device to transition from the second state to the first state.

Advantages will become more apparent to those of ordinary skill in the art from the following description of the preferred aspects, which have been shown and described by way of illustration. As will be realized, the present aspects can be capable of other and different aspects, and their details are capable of modification in various respects. Accordingly, the drawings and description are to be regarded as illustrative in nature and not as restrictive.

### BRIEF DESCRIPTION OF THE DRAWINGS

FIG. 1A depicts an aircraft communication network environment according to aspects of the present disclosure.

FIG. 1B depicts an aircraft communication network environment similar to FIG. 1A in further detail according to aspects of the present disclosure.

FIG. 2A depicts an example of the communication capabilities of devices connected to an aircraft communication network according to aspects of the present disclosure.

FIG. 2B depicts an example of the communication capabilities of devices connected to an aircraft communication network, similar to FIG. 2A, but in which there is a modification to the communication capabilities of a device that is communicating information about an emergency aboard an aircraft.

FIG. 2C depicts an example of modifications to the communication capabilities of devices connected to an aircraft communication network, similar to FIG. 2B, but in which there are modifications to the communication capabilities of all devices connected to the aircraft communication network.

FIG. 3A is a flow diagram of an example method for prioritizing emergency communications over the network in the event of an emergency.

FIG. 3B is a flow diagram of another example method for prioritizing emergency communications over the network in the event of an emergency.

The figures depict embodiments of this disclosure for purposes of illustration only. One skilled in the art will readily recognize from the following discussion that alternate embodiments of the structures and methods illustrated herein may be employed without departing from the principles set forth herein. The figures are not to scale. Instead, they are drawn to clarify aspects of this disclosure. Connecting lines or connectors shown in the various figures presented are intended to represent example functional relationships, physical couplings, or logical couplings between the various elements. In general, the same reference numbers will be used throughout the drawing(s) and accompanying written description to refer to the same or like parts.

### DETAILED DESCRIPTION

### Overview

The embodiments described herein relate to techniques for prioritizing emergency communications over the network in the event of an aircraft emergency. In some implementations, a network management device may receive, from an electronic device, an indication that an emergency event has begun aboard an aircraft and that the electronic device is being used to communicate information about the emergency (e.g., to devices external to the aircraft). The network management device may modify the communication capabilities for the reporting electronic device and/or other devices connected to the in-aircraft network such that the reporting device experiences increased communication capabilities. Such modifications may include modifying an amount of bandwidth allotted to the electronic device, prioritizing communications to that device, prioritizing voice or video traffic to or from the device, deprioritizing communications to or from other devices connected to the in-aircraft network, or disconnecting other devices from the in-aircraft network.

Communication from devices aboard an aircraft to outside devices may be challenging. Communication resources are limited to resources aboard the aircraft. There may be multiple devices aboard an aircraft sharing limited network resources. As a result, the network may be congested, which may reduce the rate of data transfer and the quality of voice or video calls. During a medical emergency, an electronic device may be used to communicate critical information about the emergency that is used to determine how to best respond to the emergency. Thus, in a medical emergency, it is important for the electronic device communicating information to have the best connection available to ensure that medical personnel can timely receive accurate information and make the best decisions possible regarding the patient care, thus improving the overall patient quality of care as well as reducing likelihood of further injury to the patient.

The present techniques offer many advantageous improvements. In particular, the present techniques may use an application programming interface (API) for reporting and modifying the communication capabilities of devices aboard the aircraft (e.g., a central authentication service (CAS) API). The use of an API streamlines the process of determining which device requires increased communication capabilities. Further, the use of an API also ensures the electronic device operates in a state which includes increased communication capabilities immediately after being notified of the emergency rather than adjusting in response to congestion, thus ensuring the device has quality communications throughout the emergency. The use of an API also enables the network management device to easily interface and communicate with a wide variety of devices which need not be limited to those belonging to the crew.

The present techniques may also modify the communication capabilities of other electronic devices aboard the aircraft that are not communicating information about the emergency. For example, deprioritizing or disconnecting other devices increases the network resources available for the device communicating information about the emergency. The device communicating information about the emergency can utilize the network resources made available by the deprioritizing or disconnection other devices, which ensures the device communicating information about the emergency can better communicate with medical and other emergency personnel outside the aircraft.

Ensuring the best connection possible for the device also ensures the patient aboard the aircraft has improved access to immediate care. For example, the device can be used to consult with a doctor, who can advise on how best to care for the patient while the patient is still aboard the aircraft. The doctor may also be able to determine if landing the aircraft will improve the condition of a patient, and what resources to provide at the landing site.

Reference will now be made in detail to the various embodiments and aspects of the present disclosure illustrated in the accompanying drawings. Wherever possible, the same or like reference numbers will be used throughout the drawings to refer to the same or like features. Certain terminology is used in the following description for convenience only and is not limiting.

### Exemplary Communication Network Environment

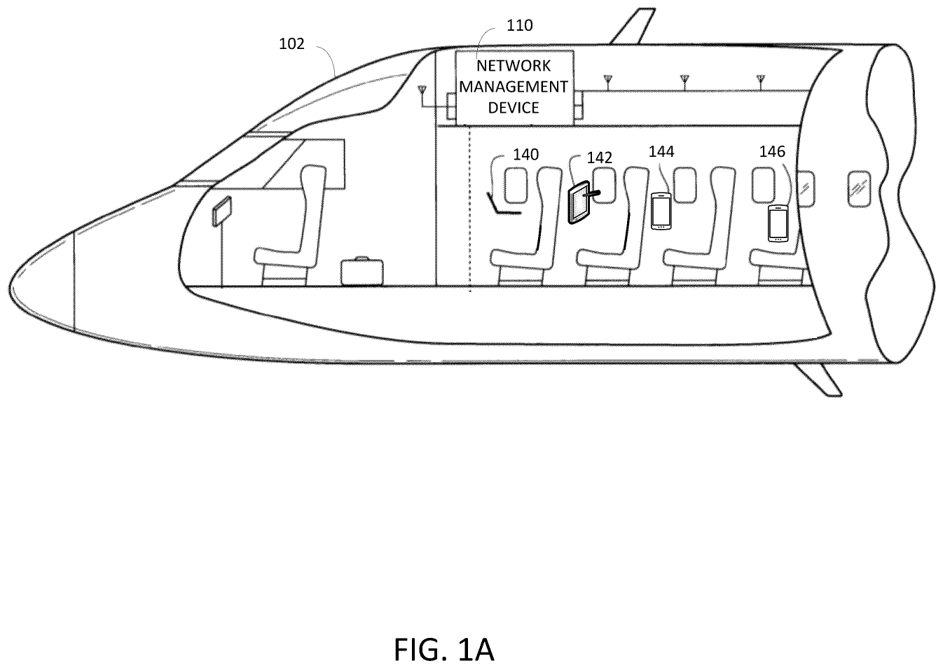

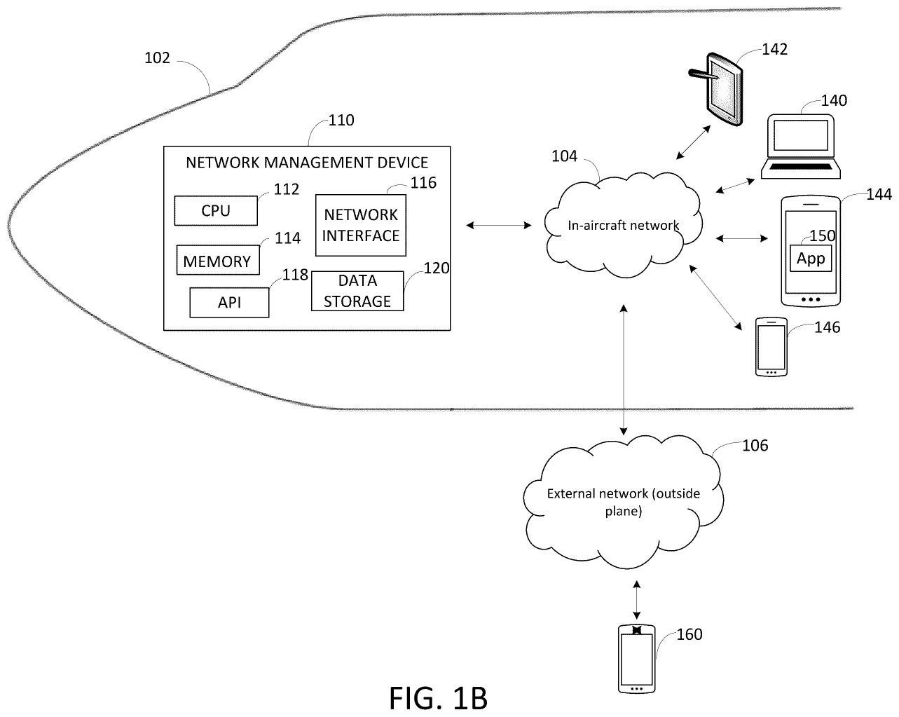

FIGS. 1A and 1B depict a vehicle communication network environment, in accordance with various aspects of the present disclosure. While FIGS. 1A and 1B illustrate various components that can be included in the network environment, depicted components may be replaced with alternate versions, additional components can be added, and components which are illustrated can be removed.

As illustrated in FIGS. 1A and 1B, the network environment 100 may include an aircraft 102, a network management device 110. The aircraft 102 may include passengers that are using electronic devices 140, 142, 144, and 146. FIG. 1B depicts the vehicle communication network environment in further detail. As illustrated in FIG. 1B, the network environment may include an aircraft 102, network management device 110, and electronic devices 140, 142, 144, and 146. The network management device 110 and electronic devices 140, 142, 144, and 146 may be communicatively coupled via an in-aircraft network 104. In some implementations, the in-aircraft network 104 operates under normal circumstances according to a predetermined data transfer protocol (e.g., a 429 Protocol). The in-aircraft network 104 may be connected to an external network 106. An electronic device 160 located externally to the aircraft may be connected to the external network 106. Electronic device 160 may communicate with devices 140, 142, 144, and 146 via networks 106 and 104.

The electronic devices 140, 142, 144, 146, and 160 can be any type of electronic device with communication capabilities such as a mobile device (e.g., a cell phone, a smart phone, a personal digital assistant (PDA), a tablet, a laptop, an e-reader, a gaming console, or smart glasses, a smart watch, a headset, or other wearable device), or any other type of electronic device. For example, in FIG. 1A, device 140 is a laptop, device 142 is a tablet, and devices 144, 146, and 160 are mobile phones. Electronic devices may be wired or connected to the in-aircraft network wirelessly. The electronic devices may be associated with passengers or with crew members. The electronic devices 140, 142, 144, and 146 may also include a medical event application (app) 150 for reporting a medical emergency.

The network management device 110 may be used to manage the communication capabilities of devices aboard an aircraft. The network management device 110 may include one or more servers, cloud computing devices, network appliances, etc.

The network management device 110 may include one or more processors 112. The processor 112 may include one or more suitable processors (e.g., central processing units (CPUs), graphical processing units (GPUs), digital signal processors (DSPs), application specific integrated circuits (ASICs), field programmable gate arrays (FPGAs), or any other suitable processors). The processors 112 may be connected to a memory 114 in order to execute instructions stored in the one or more memories 114.

The memory 142 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. The memory 142 may store an operating system (OS) (e.g., Microsoft Windows, Linux, UNIX, etc.) capable of facilitating the functionalities, apps, methods, or other software as discussed herein. The memory 142 may store sets of computer-executable instructions to implement the methods as described herein.

The memory 142 of network management device 110 may include an application programming interface (API) 118. The API 118 may facilitate modifying communication capabilities for electronic devices 140, 142, 144, and 146. The API 124 may be implemented as an endpoint accessible via a web service protocol, such as representational state transfer (REST), Simple Object Access Protocol (SOAP), JavaScript Object Notation (JSON), etc.

The network management device 110 may include a network interface controller (NIC) 116. The network interface may be an Ethernet interface, a WAN interface, or a Wi-Fi interface. The NIC 116 facilitates networking over the network 116 between the network management device and other devices in the environment.

The data storage 120 may store data entries containing information about the communication capabilities for each electronic device, such as device 140, 142, 144, or 146, connected to an in-aircraft network 104. Although FIG. 1B depicts data storage 120 as a component of the network management device 110, data storage 120 may be located externally to the network management device 110 within the aircraft, and connected to the network management device 110 through the in-aircraft network. In some implementations, data storage 120 may be located externally to the aircraft and may be accessible through the external network 106.

The network management device 110 may manage the communication capabilities of the electronic devices 140, 142, 144, and 146. The network management device 110 may interact with the data storage to manage data entries containing information about the communication capabilities of various electronic devices. The network management device 110 may identify each of the electronic devices 140, 142, 144, and 146 by IP address, token, or some other identifier, and associate each device with a set of communication capabilities.

The network management device 110 may utilize a variety of techniques to manage the communication capabilities of electronic devices aboard an aircraft. For example, the network management device 110 may manage the communication capabilities by allocating network resources such as bandwidth, prioritizing or deprioritizing traffic by using techniques such as deep packet inspection (DPI), disconnecting devices from the network, and allowing or rejecting requests to join the network. The network management device 110 may also buffer and delay traffic that exceeds the allocated bandwidth for a given electronic device. The network management device may apply different bandwidth limits to different application traffic. For example, the network management device may throttle the bandwidth of streaming services while providing additional bandwidth to audio or video communications in an emergency event. The network may apply these techniques for the entire aircraft 102 or for specific devices aboard the aircraft.

### Exemplary Communication Modifications

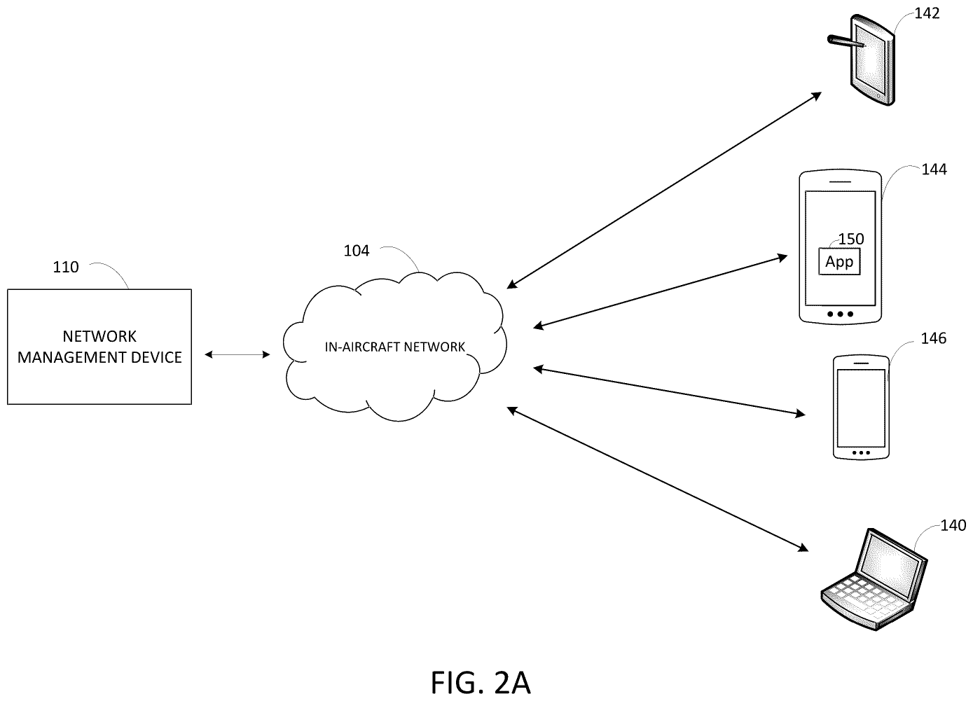

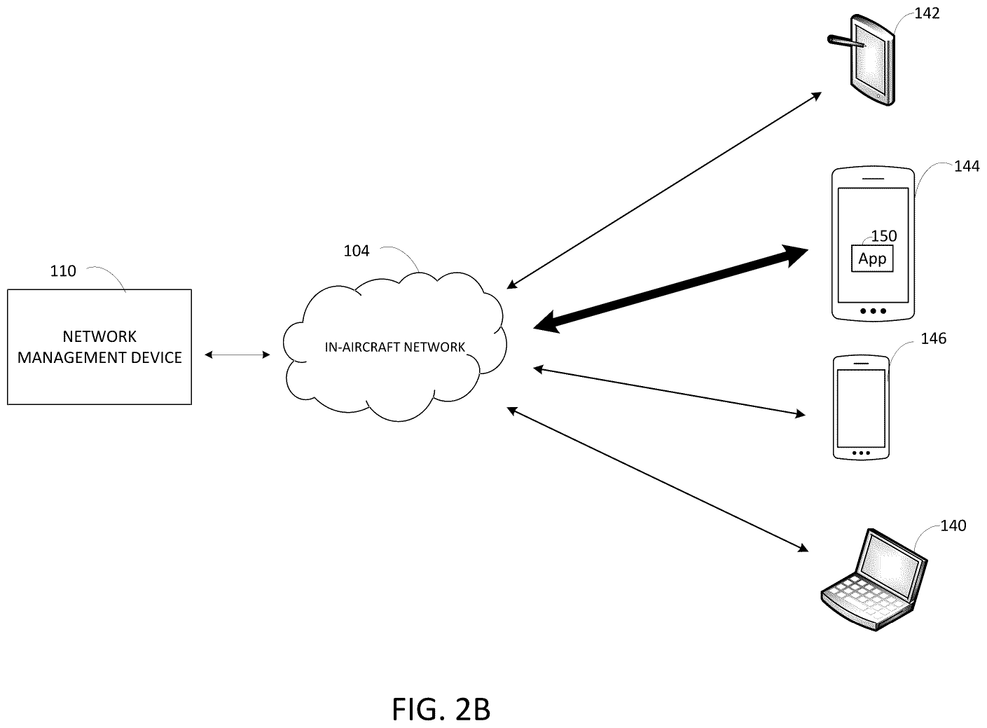

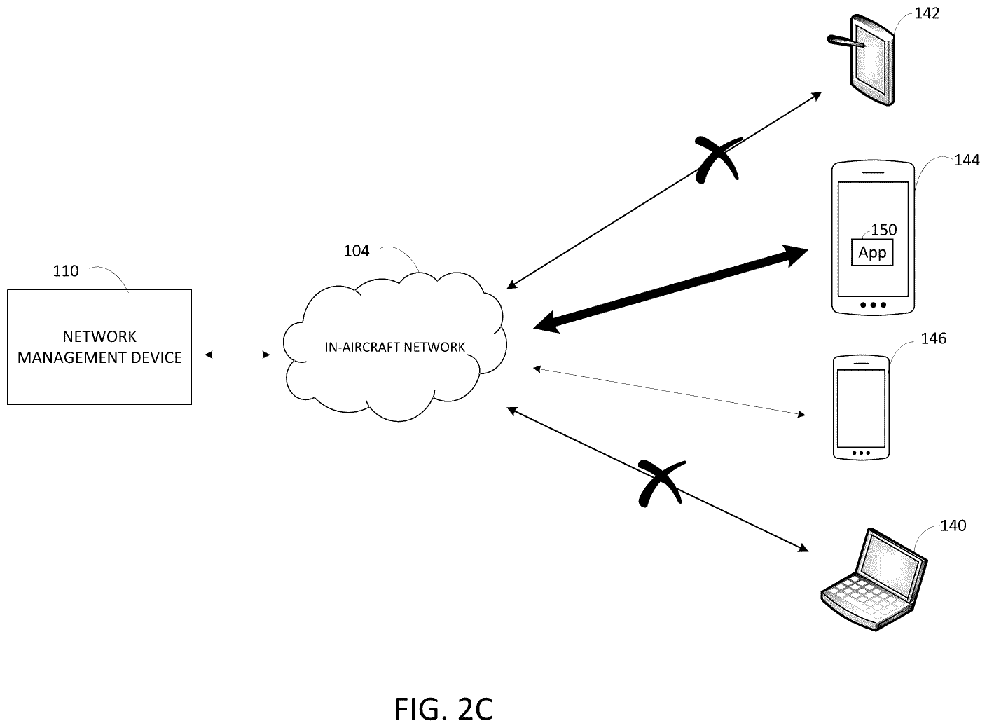

FIGS. 2A-2C depict examples of the network management device managing communication capabilities.

FIG. 2A depicts an example of the computing environment in a non-emergency situation. The network management device 110 and electronic devices 140, 142, 144, and 146 located aboard an aircraft (such as aircraft 102 as depicted in FIGS. 1A and 1B) are communicatively coupled via the in-aircraft network 104. The network management device 110 controls the communication capabilities, including access to the in-aircraft network 104, of each device connected to the in-aircraft network. Each of devices 140, 142, 144, and 146 may be associated with a set of communication capabilities for each device. The information about the communication capabilities for each device is stored in a data storage such as data storage 120 as shown in FIG. 1B. The communication capabilities may include an amount of bandwidth allocated to a device, a rate limit for a device, whether the device may utilize a particular application, the level of priority for traffic to and from a device, and levels of priority for certain services or applications. The communication capabilities may be automatically determined for all devices by the network management device 110 or may be at least partially determined by the users of the electronic devices. For example, a provider in-flight Internet and other connectivity services may offer different connectivity plans for passengers to purchase and/or otherwise utilize (e.g., a plan for just text messaging, a plan for just text messaging and email, a plan for full video streaming, a plan for full internet access, etc.). Under these plans, an electronic device may be allocated only a limited amount of bandwidth or may not be able to access and utilize certain types of applications or services.

In particular, FIG. 2A depicts the communication capabilities of the devices 140, 142, 144, and 146 in a state before a medical emergency has begun. The devices in 140, 142, 144, and 146 as shown in FIG. 2A have similarly limited communication capabilities before a medical emergency event has begun. In some implementations, although the devices have similar communication capabilities, the communication capabilities need not be identical for each device. For example, one device may have more allotted bandwidth before the emergency has begun due to the user of the device purchasing a higher connection plan.

In FIG. 2B, an emergency event aboard the aircraft has begun and/or been detected. In response to the emergency event, an electronic device 144 reports the medical emergency. In some implementations, a user may open a medical event application 150 on the electronic device 144 to report the medical emergency. The user of electronic device 144 may be a crew member or a passenger aboard the aircraft 102. In other implementations, a medical device, such as a pacemaker, may detect an irregularity and trigger the electronic device 144 to report the emergency. Similarly, in some implementations, the electronic device 144 detects a signal, irregularity, a value above or below a predetermined threshold, and/or other such indication of a potential medical event and/or emergency. The electronic device 144 may then automatically report the medical emergency, prompt a user to report the medical emergency, start a timer before automatically reporting the medical emergency, etc.

When the emergency is reported, the electronic device 144 calls an API 118 (such as API 118 as shown in FIG. 1B) to inform the network management device 110 aboard the aircraft 102 that the device 144 is being used to communicate information about the emergency to a device external to the aircraft 102 (e.g., electronic device 160 in FIG. 1B). The electronic device 160 may be associated with medical or other emergency services personnel on the ground. Upon activation, the network management device 110 uses the API 118 to identify and modify the communications capabilities of the electronic device 144. The network management device 110 may identify the device 144 as the reporting device by using device 144's media access control (MAC) address. The network management device 110 may modify the communication capabilities of the electronic device 144 by increasing an allocation of bandwidth to the electronic device 144 to improve the communication capabilities of electronic device 144. The bandwidth may be increased to a maximum allowable by network constraints (for example, the equipment aboard aircraft 102), or may be increased but not to the maximum allowable by network constraints.

In some implementations, the network management device 110 may also enable the electronic device 144 to utilize services that electronic device 144 may not have been able to utilize before the emergency event had begun. For example, a user of electronic device 144 may have selected a lower connectivity plan that did not include the ability to make video or voice calls. After the emergency has begun, the network management device 110 may allow the electronic device 144 to make video or voice calls despite the user's initial connectivity plan. Additionally or alternatively, the network management device 110 may increase the communication capabilities of the electronic device 144 by prioritizing some or all kinds of traffic to electronic device 144. For example, all data traffic to and from electronic device 144 may receive a higher priority than traffic associated with other devices connected to the network (e.g., electronic devices 140, 142, and 146). Additionally or alternatively, the network management device 144 may specifically prioritize traffic associated with communicating information about the emergency (e.g., traffic associated with a video or voice call between electronic device 144 and electronic device 160). The network management device 110 may utilize DPI to inspect data packets and eliminate those which do not adhere to the set of communication capabilities for a device. Depending on the implementation, the network management device 110 may utilize various techniques in performing DPI, such as packet parsing, pattern matching, protocol analysis, stateful inspection, application layer inspection, flow analysis, etc.

In FIG. 2C, the network management device makes additional modifications to the communication capabilities of other devices connected to the in-aircraft network 104. As shown in FIG. 2C, device 144 has increased bandwidth compared to other devices, similarly to FIG. 2B. The network management device 110 decreases the bandwidth allocated to electronic device 146. The network management device 110 may also make alternate or additional changes to the communication capabilities of electronic device 146, such as deprioritizing traffic to and from electronic device 146. In some implementations, the network management device 110 also disconnects electronic devices 140 and 142 from the network. These additional modifications help improve the ability of electronic device 144 to communicate information about the medical emergency to an external device such as electronic device 160 of FIG. 1B by reducing network congestion and allowing the electronic device 144 to utilize more network resources.

In some implementations, the network management device 110 determines to perform traffic shaping of the traffic on the aircraft by prioritizing or deprioritizing traffic (e.g., as described herein) responsive to a determination that overall bandwidth usage is above a predetermined threshold. For example, in some such implementations, if the network management device 110 determines that enough bandwidth is being used on the aircraft so as to cause potential communication problems, the network management device 110 determines to enact the techniques described herein for prioritizing and/or deprioritizing traffic or devices. In other implementations, if the network management device 110 determines that bandwidth is not above the predetermined threshold, the network management device 110 determines not to prioritize or deprioritize traffic. In still further implementations, if the network management device 110 receives an indication of connectivity problems (e.g., from the electronic device 144), the network management device 110 prioritizes traffic, deprioritizes traffic, and/or disconnects devices (e.g., electronic devices 140 and/or 142) from the network 104 regardless of the used bandwidth. In yet still further implementations, the network management device 110 automatically prioritizes traffic, deprioritizes traffic, and/or disconnects devices regardless of bandwidth usage, connectivity status, etc.

The techniques utilized by the network management device 110 in FIGS. 2A-2C for electronic device 140, 142, 144, and 146 may be used individually or in combination with each other.

### Exemplary Methods of Modifying Communication Capabilities for an Emergency Event

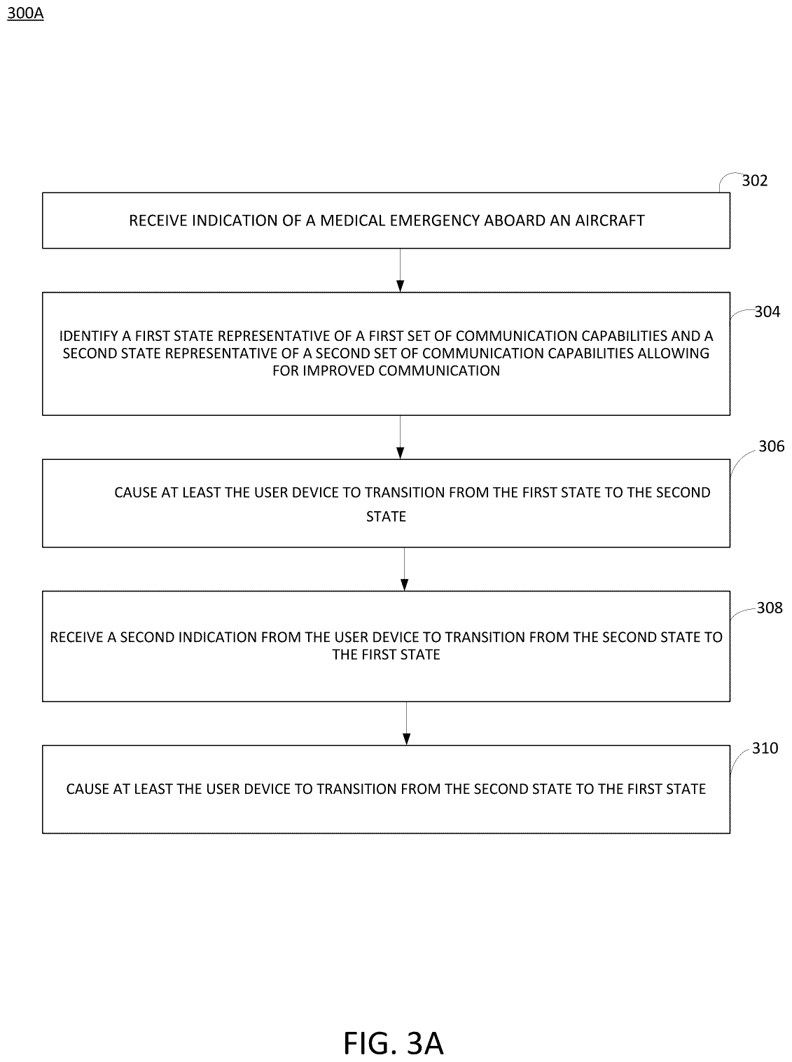

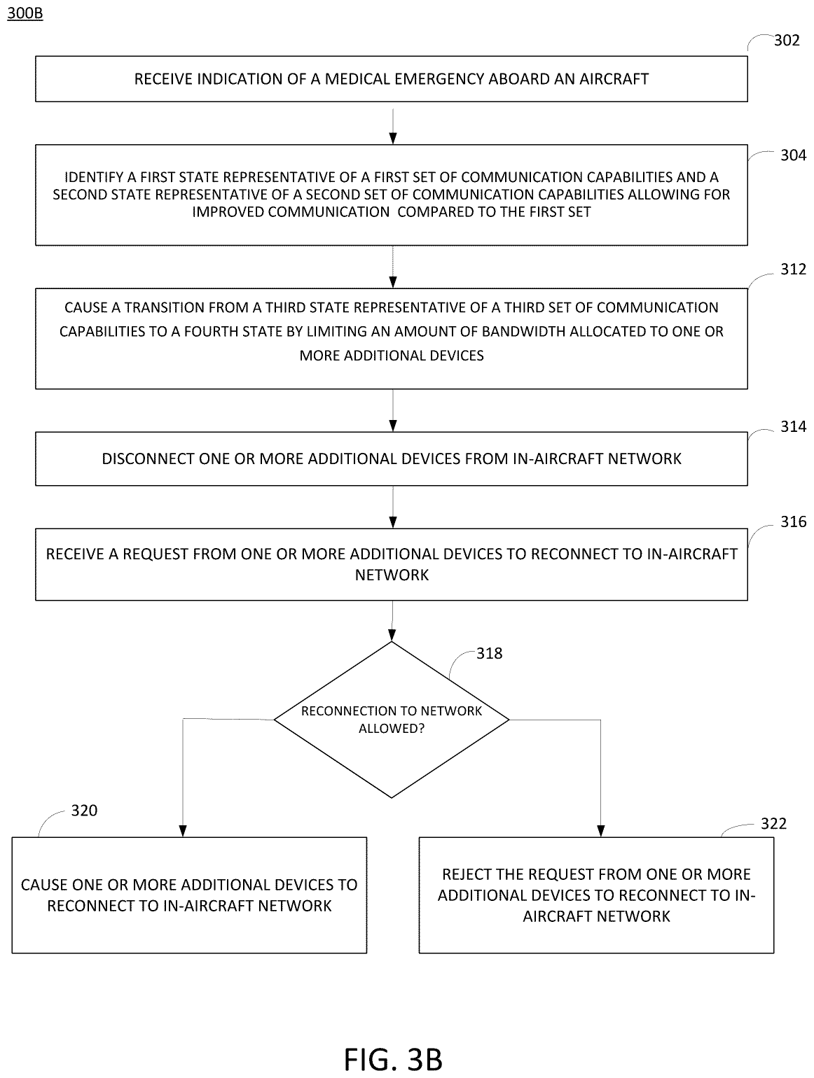

FIGS. 3A and 3B depict flow diagrams of example methods for modifying communication capabilities for an emergency event. One or more steps of the computer-implemented methods of 300A and 300B may be implemented as a set of instructions stored on a computer-readable memory and executable on one or more processors. The computer-implemented methods 300A and 300B may operate in the environment illustrated in FIGS. 1A and 1B.

FIG. 3A depicts an example method for modifying the communication capabilities of a user device being used to communicate information about the emergency. The method may be performed by a network management device, such as network management device 110 as shown FIGS. 1A and 1B, in communication with an electronic device being used to communicate information about the emergency, such as the electronic device 144 as shown in FIGS. 1A and 1B, over an in-aircraft network such as the in-aircraft network 104 as shown in FIG. 1B. The electronic device 144 may be installed on the aircraft, or it may be a mobile device associated with either a passenger or a crew member.

At block 302, the network management device 110 may receive an indication of a medical emergency aboard an aircraft. The indication may be received via an API such as API 118 of FIG. 1B. A user may access a medical event application on the electronic device 144 connected to the in-aircraft network 104. In some implementations, user may use the application to manually report the medical emergency and to notify the network management device 110 that the reporting device (e.g., electronic device 144) is being used to communicate information about the medical emergency to a device located externally to the aircraft, such as electronic device 160 as shown in FIG. 1B. In another aspect, a medical device, such as a pacemaker, may detect an irregularity and trigger the electronic device 144 to automatically report the medical emergency. Similarly, in some implementations, the electronic device 144 may detect a signal, irregularity, a value above or below a predetermined threshold, and/or other such indication of a potential medical event and/or emergency, and may then automatically report the medical emergency or prompt a user to report the medical emergency, start a timer before automatically reporting the medical emergency, etc.

The application communicates with the network management device 110 via API 118. The API 118 may be implemented as an endpoint accessible via a web service protocol, such as representational state transfer (REST), Simple Object Access Protocol (SOAP), JavaScript Object Notation (JSON), etc. The network management device 110 may identify the electronic device 144 by the MAC address associated with electronic device 144. In some implementations, the network management device 110 may identify devices by detecting use of the application 150 or through the phone number of a device with which the electronic device 144 communicates.

At block 304, the network management device 110 may identify a first state representative of a first asset of communication capabilities and a second state representative of a second set of communication capabilities allowing for improved communication for at least the electronic device 144. The first set of communication capabilities of electronic device 144 may be included in a data entry associated with the electronic device 144 and stored in the data storage 120. The first set of communication capabilities may include information on how the electronic device 144 was initially permitted to utilize network resources before the emergency event begun. The second set of communication capabilities may include information on how electronic device 144 may utilize network resources to allow for improved communication to and from the electronic device 144 after the emergency event has begun. In one aspect, the second set of communication capabilities may be applied to only electronic device 144 and may include increasing the bandwidth allocated to the device 144. The bandwidth allocated to electronic device 144 may be increased up to the maximum that is able to be allocated based on network constraints such as the on-board equipment and signal strength. Alternately, the bandwidth allocated to electronic device 144 may be increased, but not to the maximum allowable by network constraints. In another aspect, the second set of communication capabilities may apply to all electronic devices connected to the in-aircraft network. Applying the second set of communication capabilities may include increasing bandwidth for all devices connected to the in-aircraft network, such that device 144 as well as 140, 142, and 146 are allocated increased bandwidth, and thus all experience increased communication capabilities. Alternately or additionally, the second set of communication capabilities may include allowing or prioritizing traffic associated with certain services or applications. For example, phone or video calls from electronic device 144 may be prioritized over other types of internet traffic, e.g., email, streaming, etc.

At block 306, the network management device 110 may cause at least the electronic device 144 to transition from the first state to the second state. The network management device 110 may cause the transition by modifying the set of communication capabilities associated with electronic device 144 and stored in data storage 120 from the first set to the second set, and then allocating resources and directing traffic based on the second set of communication capabilities. In one aspect, the network management device 110 may cause only electronic device 144 to transition to the second state representative of the second set of communication capabilities. In another aspect, the network management device 110 may cause one or more additional electronic devices, up to all electronic devices connected to the in-aircraft network 104, to transition to the second state representative of a second set of communication capabilities.

At block 308, the network management device 110 may receive a second indication from the user device 144 to transition from the second state representing a second set of communications capabilities to the first state representing a first set of communications capabilities. When the medical emergency has ended, the user of electronic device 144 may use the medical event application to report that the emergency has ended. The electronic device 144 indicates to the network management device 110 via the API 118 that the emergency is over and that the electronic device 144 is no longer being used to communicate information regarding the emergency.

At block 310, the network management device 110 may cause at least the electronic device 144 to transition from the second state representing a second set of communications capabilities the first state representing a first set of communications capabilities. In the second state representative of a second set of communication capabilities, the electronic device 144 had improved communication capabilities for communicating information about the emergency. After the emergency event has ended, the electronic device 144 no longer requires improved capabilities to communicate information about the emergency and thus may be returned to the communication state in which it operated before the emergency had begun (e.g., the first state representative of a first set of communication capabilities). Additionally, any other devices which operated under the second set of communication capabilities may also be returned to the first state representing the first set of communication capabilities. In some implementations, the device 144 may disconnect from the in-aircraft network 104 or begin to operate in a state different from the first state.

FIG. 3B depicts another example method for modifying communications capabilities of a user device in a medical emergency. Blocks 302-306 of FIG. 3B are similar to the blocks 302-306 of FIG. 3A.

After the network management device 110 causes the electronic device 144 to transition from a first state representative of a first set of communication capabilities to a second set of representative of a second set of communication capabilities, the network management device 110 causes a transition from a third state representative of a third set of communication capabilities to a fourth state representative of a fourth set of communication capabilities for one or more additional electronic devices connected to the in-aircraft network 104 at block 312. In the fourth state representative of the fourth set of communication capabilities, the network management device 110 limits the amount bandwidth allocated to one or more additional devices connected to the in-aircraft network 104 (e.g., one or more of electronic devices 140, 142, or 146 as shown in FIGS. 1A and 1B). In some implementations, one or more of the electronic devices and may be exempt from changes in the communication capabilities, such as devices connected by wire, devices that assist in aircraft operations, or pre-registered devices.

Alternately or additionally, at block 314 the network management device 110 may disconnect one or more additional devices from the in-aircraft network 104. Electronic devices 140, 142, and 146 may be disconnected from the in-aircraft network 104, while device 144 remains connected to the in-aircraft network in order to communicate information about the medical emergency. The network management device 110 may disconnect all electronic devices, or keep some devices connected while disconnecting others. For example, the network management device 110 may disconnect electronic devices associated with aircraft passengers, while aircraft and crew devices remain connected to the in-aircraft network 104. In one implementation, the network management device 144 may identify which devices are to remain connected by protocol or by programmed logic. In some implementations, one or more of the electronic devices may be exempt from changes in the communication capabilities. In one implementation, a device that is exempt from changes in communication capabilities may be connected by wire to the in-aircraft network 104 by wire. In another implementation, a device that is exempt from changes in communication capabilities may be a device used to assist in operation of the aircraft. In another implementation, an electronic device that is to exempt from changes in communication capabilities may be a device associated with a crew member such as a flight attendant. Prior to the flight, a crew member may use the medical event application 150 and/or another application on the electronic device to register an electronic device as a crew member device. The network management device 110 may use such registration information to identify the electronic device 144 as one that should remain connected to the in-aircraft network 104 during the aircraft emergency.

After the one or more additional devices have been disconnected, the one or more additional devices may attempt to rejoin the in-aircraft network 104. At block 318, reconnection to the in-aircraft may be allowed or disallowed by the network management device 110. Reconnection may be allowed, for example, in order for the reconnecting device to assist with communicating information about the emergency to an external electronic device such as electronic device 160 as shown in FIG. 1B. If reconnection is allowed, the network management device 110 may cause one or more requesting devices to reconnect to the in-aircraft network 104. If reconnection is not allowed, the network management device 110 may reject the request to reconnect to the in-aircraft network from the one or more additional devices.

### Additional Considerations

As used herein, the terms “receive,” “received,” and “receiving” may refer to collecting performance metrics transmitted by an on-board node and/or base station or retrieving the performance metrics from the on-board node and/or base station. It will be appreciated that the term receive is not limited to these examples only and may have alternative, different and/or other features and still fall within the scope of present disclosure.

As used herein, the terms “meter,” “metered,” and “metering” may refer to allocating bandwidth limits or enforcing the bandwidth limits. It will be appreciated that the term meter is not limited to these examples only and may have alternative, different and/or other features and still fall within the scope of present disclosure.

Use of “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise. A device or structure that is “configured” in a certain way is configured in at least that way but may also be configured in ways that are not listed.

Further, as used herein, the expressions “in communication,” “coupled” and “connected,” “communicatively coupled,” etc. including variations thereof, encompasses direct communication and/or indirect communication through one or more intermediary components, and does not require direct mechanical or physical (e.g., wired) communication and/or constant communication, but rather additionally includes selective communication at periodic intervals, scheduled intervals, aperiodic intervals, and/or one-time events. The embodiments are not limited in this context.

Further still, unless expressly stated to the contrary, “or” refers to an inclusive or and not to an exclusive or. For example, “A, B or C” refers to any combination or subset of A, B, C such as (1) A alone, (2) B alone, (3) C alone, (4) A with B, (5) A with C, (6) B with C, and (7) A with B and with C. As used herein, the phrase “at least one of A and B” is intended to refer to any combination or subset of A and B such as (1) at least one A, (2) at least one B, and (3) at least one A and at least one B. Similarly, the phrase “at least one of A or B” is intended to refer to any combination or subset of A and B such as (1) at least one A, (2) at least one B, and (3) at least one A and at least one B.

Moreover, in the foregoing specification, specific embodiments have been described. However, one of ordinary skill in the art appreciates that various modifications and changes can be made in view of aspects of this disclosure without departing from the scope of the invention as set forth in the claims below. Accordingly, the specification and figures are to be regarded in an illustrative rather than a restrictive sense, and all such modifications made in view of aspects of this disclosure are intended to be included within the scope of present teachings.

Additionally, the benefits, advantages, solutions to problems, and any element(s) that may cause any benefit, advantage, or solution to occur or become more pronounced are not to be construed as a critical, required, or essential features or elements of any or all the claims.

Finally, any references, including, but not limited to, publications, patent applications, and patents cited herein are hereby incorporated in their entirety by reference to the same extent as if each reference were individually and specifically indicated to be incorporated by reference and were set forth in its entirety herein.

The patent claims at the end of this patent application are not intended to be construed under 35 U.S.C. § 112(f) unless traditional means-plus-function language is expressly recited, such as “means for” or “step for” language being explicitly recited in the claim(s). The communication systems and methods described herein are directed to improvements to computer and communication system functionality and performance.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

This detailed description is to be construed as exemplary only and does not describe every possible embodiment, as describing every possible embodiment would be impractical, if not impossible. One could implement numerous alternate embodiments, using either current technology or technology developed after the filing date of this application.

Moreover, although the foregoing text sets forth a detailed description of numerous different embodiments, it should be understood that the scope of the patent is defined by the words of the claims set forth at the end of this patent. Numerous alternative embodiments could be implemented, using either current technology or technology developed after the filing date of this patent, which would still fall within the scope of the claims. By way of example, and not limitation, the disclosure herein contemplates at least the following aspects:

Aspect 1. A computer-implemented method for modifying communication capabilities for an emergency event, the method comprising: receiving, by one or more processors and via an application programming interface, a first indication from a user device that an emergency event has begun aboard an aircraft; identifying, by the one or more processors, a first state representative of a first set of communication capabilities for at least the user device and a second state representative of a second set of communication capabilities for at least the user device such that the second set of communication capabilities allows for improved communication from the user device compared to the first set of communication capabilities; causing, by the one or more processors and in response to receiving the first indication, at least the user device to transition from the first state to the second state; receiving, by the one or more processors, a second indication from the user device to transition from the second state to the first state; and causing, by the one or more processors and in response to receiving the second indication, at least the user device to transition from the second state to the first state.

Aspect 2. The computer-implemented method of aspect 1, wherein causing at least the user device to transition from the first state to the second state comprises: increasing an allocation of a maximum amount of bandwidth to the user device.

Aspect 3. The computer-implemented method of aspect 1, wherein causing at least the user device to transition from the first state to the second state comprises: modifying an allocation of a respective maximum amount of bandwidth to each device of a plurality of devices connected to an in-aircraft network including the user device.

Aspect 4. The computer-implemented method of aspect 1, further comprising: causing, by the one or more processors, a transition from a third state representative of a third set of communication capabilities for one or more additional devices connected to an in-aircraft network to a fourth state representative of a fourth set of communication capabilities for the one or more additional devices by limiting an amount of bandwidth allocated to the one or more additional devices, wherein the user device is also connected to the in-aircraft network.

Aspect 5. The computer-implemented method of claim 1, further comprising: disconnecting one or more additional devices from an in-aircraft network, wherein the user device remains connected to the in-aircraft network.

Aspect 6. The computer-implemented method of aspect 5, further comprising: receiving via one or more processors, a request from at least one of the one or more additional devices to reconnect to the in-aircraft network; and causing, via one or more processors, the at least one of the one or more additional devices to reconnect to the in-aircraft network.

Aspect 7. The computer-implemented method of aspect 5, further comprising: receiving, via the one or more processors, a request from at least one of the one or more additional devices to reconnect to the in-aircraft network; and rejecting, via the one or more processors, the request from the one or more additional devices to reconnect to the in-aircraft network.

Aspect 8. A computer system for modifying communication capabilities for an emergency event, the system comprising: one or more processors; and a memory storing instructions that, when executed, cause the one or more processors to: receive, via an application programming interface, a first indication from a user device that an emergency event has begun aboard an aircraft; identify, a first state representative of a first set of communication capabilities for at least the user device and a second state representative of a second set of communication capabilities for at least the user device such that the second set of communication capabilities allows for improved communication from the user device compared to the first set of communication capabilities; cause, in response to receiving the first indication, at least the user device to transition from the first state to the second state; receive a second indication from the user device to transition from the second state to the first state; and cause, in response to receiving the second indication, at least the user device to transition from the second state to the first state.

Aspect 9. The computer system of aspect 8, wherein causing at least the user device to transition from the first state to the second state comprises: increasing an allocation of a maximum amount of bandwidth to the user device.

Aspect 10. The computer system of aspect 8, wherein causing at least the user device to transition from the first state to the second state comprises: modifying an allocation of a respective maximum amount of bandwidth to each device of a plurality of devices connected to an in-aircraft network including the user device.

Aspect 11. The computer system of aspect 8, wherein the memory includes instructions that, when executed, further cause the one or more processors to: cause a transition from a third state representative of a third set of communication capabilities for one or more additional devices connected to an in-aircraft network to a fourth state representative of a fourth set of communication capabilities for the one or more additional devices by limiting an amount of bandwidth allocated to the one or more additional devices, wherein the user device is also connected to the in-aircraft network.

Aspect 12. The computer system of aspect 8, wherein the memory includes instructions that, when executed, further cause the one or more processors to: disconnect one or more additional devices from an in-aircraft network, wherein the user device remains connected to the in-aircraft network.

Aspect 13. The computer system of aspect 12, wherein the memory includes instructions that, when executed, further cause the one or more processors to: receive a request from at least one of the one or more additional devices to reconnect to the in-aircraft network; and cause the at least one of the one or more additional devices to reconnect to the in-aircraft network.

Aspect 14. The computer system of aspect 12, wherein the memory includes instructions that, when executed, further cause the one or more processors to: receive a request from at least one of the one or more additional devices to reconnect to the in-aircraft network; and reject the request from the one or more additional devices to reconnect to the in-aircraft network.

Aspect 15. A non-transitory computer-readable medium storing processor-executable instructions for modifying communication capabilities that, when executed by one or more processors, cause the one or more processors to: receive, via an application programming interface, a first indication from a user device that an emergency event has begun aboard an aircraft; identify, a first state representative of a first set of communication capabilities for at least the user device and a second state representative of a second set of communication capabilities for at least the user device such that the second set of communication capabilities allows for improved communication from the user device compared to the first set of communication capabilities; cause, in response to receiving the first indication, at least the user device to transition from the first state to the second state; receive a second indication from the user device to transition from the second state to the first state; and cause, in response to receiving the second indication, at least the user device to transition from the second state to the first state.

Aspect 16. The non-transitory computer-readable medium of aspect 15, wherein the processor-executable instructions that cause at least the user device to transition from the first state to the second state include instructions to: increase an allocation of a maximum amount of bandwidth to the user device.

Aspect 17. The non-transitory computer-readable medium of aspect 15, wherein the processor-executable instructions that cause at least the user device to transition from the first state to the second state include instructions to: modify an allocation of a respective maximum amount of bandwidth to each device of a plurality of devices connected to an in-aircraft network including the user device.

Aspect 18. The non-transitory computer-readable medium of aspect 15, storing further instructions to: cause a transition from a third state representative of a third set of communication capabilities for one or more additional devices connected to an in-aircraft network to a fourth state representative of a fourth set of communication capabilities for the one or more additional devices by limiting an amount of bandwidth allocated to the one or more additional devices, wherein the user device is also connected to the in-aircraft network.

Aspect 19. The non-transitory computer-readable medium of aspect 15, storing further instructions to: disconnect one or more additional devices from an in-aircraft network, wherein the user device remains connected to the in-aircraft network.

Aspect 20. The non-transitory computer-readable medium of aspect 19, storing further instructions to: receive a request from at least one of the one or more additional devices to reconnect to the in-aircraft network; and reject the request from the one or more additional devices to reconnect to the in-aircraft network.

What is claimed:

1. A computer-implemented method for modifying communication capabilities for an emergency event, the method comprising:
receiving, by one or more processors and via an application programming interface, a first indication from a user device that an emergency event has begun aboard an aircraft;
identifying, by the one or more processors, a first state representative of a first set of communication capabilities for at least the user device and a second state representative of a second set of communication capabilities for at least the user device such that the second set of communication capabilities allows for improved communication from the user device compared to the first set of communication capabilities;
causing, by the one or more processors and in response to receiving the first indication, at least the user device to transition from the first state to the second state;
receiving, by the one or more processors, a second indication from the user device to transition from the second state to the first state; and
causing, by the one or more processors and in response to receiving the second indication, at least the user device to transition from the second state to the first state.

2. The computer-implemented method of claim 1, wherein causing at least the user device to transition from the first state to the second state comprises:
increasing an allocation of a maximum amount of bandwidth to the user device.

3. The computer-implemented method of claim 1, wherein causing at least the user device to transition from the first state to the second state comprises:
modifying an allocation of a respective maximum amount of bandwidth to each device of a plurality of devices connected to an in-aircraft network including the user device.

4. The computer-implemented method of claim 1, further comprising:
causing, by the one or more processors, a transition from a third state representative of a third set of communication capabilities for one or more additional devices connected to an in-aircraft network to a fourth state representative of a fourth set of communication capabilities for the one or more additional devices by limiting an amount of bandwidth allocated to the one or more additional devices, wherein the user device is also connected to the in-aircraft network.

5. The computer-implemented method of claim 1, further comprising:
disconnecting one or more additional devices from an in-aircraft network, wherein the user device remains connected to the in-aircraft network.

6. The computer-implemented method of claim 5, further comprising:
receiving via one or more processors, a request from at least one of the one or more additional devices to reconnect to the in-aircraft network; and
causing, via one or more processors, the at least one of the one or more additional devices to reconnect to the in-aircraft network.

7. The computer-implemented method of claim 5, further comprising:
receiving, via the one or more processors, a request from at least one of the one or more additional devices to reconnect to the in-aircraft network; and
rejecting, via the one or more processors, the request from the one or more additional devices to reconnect to the in-aircraft network.

8. A computer system for modifying communication capabilities for an emergency event, the system comprising:
one or more processors; and
a memory storing instructions that, when executed, cause the one or more processors to:
receive, via an application programming interface, a first indication from a user device that an emergency event has begun aboard an aircraft;
identify, a first state representative of a first set of communication capabilities for at least the user device and a second state representative of a second set of communication capabilities for at least the user device such that the second set of communication capabilities allows for improved communication from the user device compared to the first set of communication capabilities;
cause, in response to receiving the first indication, at least the user device to transition from the first state to the second state;
receive a second indication from the user device to transition from the second state to the first state; and
cause, in response to receiving the second indication, at least the user device to transition from the second state to the first state.

9. The computer system of claim 8, wherein causing at least the user device to transition from the first state to the second state comprises:
increasing an allocation of a maximum amount of bandwidth to the user device.

10. The computer system of claim 8, wherein causing at least the user device to transition from the first state to the second state comprises:
modifying an allocation of a respective maximum amount of bandwidth to each device of a plurality of devices connected to an in-aircraft network including the user device.

11. The computer system of claim 8, wherein the memory includes instructions that, when executed, further cause the one or more processors to:
cause a transition from a third state representative of a third set of communication capabilities for one or more additional devices connected to an in-aircraft network to a fourth state representative of a fourth set of communication capabilities for the one or more additional devices by limiting an amount of bandwidth allocated to the one or more additional devices, wherein the user device is also connected to the in-aircraft network.

12. The computer system of claim 8, wherein the memory includes instructions that, when executed, further cause the one or more processors to:
disconnect one or more additional devices from an in-aircraft network, wherein the user device remains connected to the in-aircraft network.

13. The computer system of claim 12, wherein the memory includes instructions that, when executed, further cause the one or more processors to:
receive a request from at least one of the one or more additional devices to reconnect to the in-aircraft network; and
cause the at least one of the one or more additional devices to reconnect to the in-aircraft network.

14. The computer system of claim 12, wherein the memory includes instructions that, when executed, further cause the one or more processors to:
receive a request from at least one of the one or more additional devices to reconnect to the in-aircraft network; and
reject the request from the one or more additional devices to reconnect to the in-aircraft network.

15. A non-transitory computer-readable medium storing processor-executable instructions for modifying communication capabilities that, when executed by one or more processors, cause the one or more processors to at least:
receive, via an application programming interface, a first indication from a user device that an emergency event has begun aboard an aircraft;
identify, a first state representative of a first set of communication capabilities for at least the user device and a second state representative of a second set of communication capabilities for at least the user device such that the second set of communication capabilities allows for improved communication from the user device compared to the first set of communication capabilities;
cause, in response to receiving the first indication, at least the user device to transition from the first state to the second state;
receive a second indication from the user device to transition from the second state to the first state; and
cause, in response to receiving the second indication, at least the user device to transition from the second state to the first state.

16. The non-transitory computer-readable medium of claim 15, wherein the processor-executable instructions that cause at least the user device to transition from the first state to the second state include instructions to:
increase an allocation of a maximum amount of bandwidth to the user device.

17. The non-transitory computer-readable medium of claim 15, wherein the processor-executable instructions that cause at least the user device to transition from the first state to the second state include instructions to:
modify an allocation of a respective maximum amount of bandwidth to each device of a plurality of devices connected to an in-aircraft network including the user device.

18. The non-transitory computer-readable medium of claim 15, storing further instructions to:
cause a transition from a third state representative of a third set of communication capabilities for one or more additional devices connected to an in-aircraft network to a fourth state representative of a fourth set of communication capabilities for the one or more additional devices by limiting an amount of bandwidth allocated to the one or more additional devices, wherein the user device is also connected to the in-aircraft network.

19. The non-transitory computer-readable medium of claim 15, storing further instructions to:
disconnect one or more additional devices from an in-aircraft network, wherein the user device remains connected to the in-aircraft network.

20. The non-transitory computer-readable medium of claim 19, storing further instructions to:
receive a request from at least one of the one or more additional devices to reconnect to the in-aircraft network; and
reject the request from the one or more additional devices to reconnect to the in-aircraft network.
